(19) United States
(12) Patent Application Publication
(10) Pub. No.: US 2013/0159149 A1
(43) Pub. Date: Jun. 20, 2013

(54) INTEGRATING PARTNER ERP SYSTEM INTO A HOST FINANCIAL SYSTEM USING GENERIC COST OBJECTS

(71) Applicants: Thomas Schachner, Heidelberg (DE); Rudolf Gentner, Waghaeusel (DE); Ralf Kuehner, Otterberg (DE); Michael Hohendorf, Waghausel (DE); Dirk Henrich, Sandhausen (DE)

(72) Inventors: Thomas Schachner, Heidelberg (DE); Rudolf Gentner, Waghaeusel (DE); Ralf Kuehner, Otterberg (DE); Michael Hohendorf, Waghausel (DE); Dirk Henrich, Sandhausen (DE)

(73) Assignee: SAP AG, Walldorf (DE)

(21) Appl. No.: 13/327,303

(22) Filed: Dec. 15, 2011

(51) Int. Cl. G06Q 40/00

(52) U.S. Cl. 705/30

(57) ABSTRACT

Systems and methods to provide integration of partner ERP systems into a host financial system using generic cost objects. In example embodiments, an accounting system having a generic cost object is maintained. A user interface for creating a configured cost object that represents a specialized business item is provided. Data that mirrors the configured cost object is received, which results in a mirror cost object. Accounting operations are performed in the accounting system based on the mirror cost object and a corresponding business control set by replacing the generic cost object with the mirror cost object. Output based on performance of the accounting operations based on the mirror cost object and corresponding business configuration set are provided.

### FIELD

The present disclosure relates generally to financial accounting, and in a specific example embodiment, to integrating a partner ERP system into a host financial system using generic cost objects.

### BACKGROUND

Conventionally when a user wants to incorporate financial information that is specialized to the needs of the user into an accounting system, the user will need to purchase a customized or specialized accounting system that addresses the needs of the user. Alternatively, the user may customize an existing account system to handle the specialized financial information by employing a programmer or developer to make changes to the existing account system. Both of these solutions, however, require the user to expend capital in order to obtain a highly specialized accounting system that may not be adaptable for other uses (e.g., a future use that is different from a specialized use case). As a result, more than one accounting system (e.g., a real estate accounting system, equipment solution accounting system, payroll accounting system) may be needed by an entity in order to manage the financials of the entity.

### BRIEF DESCRIPTION OF DRAWINGS

Various ones of the appended drawings merely illustrate example embodiments of the present invention and cannot be considered as limiting its scope.

FIG. 1 illustrates an environment in which example embodiments of the inventive subject matter may be practiced.

FIG. 2 is a block diagram illustrating a host financial system.

FIG. 3 is an example information flow diagram for configuring a cost object.

FIG. 4 is an example information flow diagram for performing accounting operations using a configured cost object on the host financial system.

FIG. 5 is an example information flow diagram for posting financial notifications to the host financial system.

FIG. 6 is a flowchart of an example method for integrating a partner ERP system into a host financial system using generic cost objects in accordance with one embodiment.

FIG. 7 is a flowchart of an example method for posting notification to the host financial system in accordance with one embodiment.

FIG. 8 is a flowchart of an example method for performing accounting operations in accordance with one embodiment.

FIG. 9 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Systems and methods for integrating a partner enterprise resource planning (ERP) system into a host financial system using generic cost objects is provided. In example embodiments, generic cost objects are maintained in an accounting system. These generic cost objects may be replaced with a configured cost object that is specialized to a business' needs. The configured cost object may comprise software that represents an item that a partner may build business functions upon. For example, if the cost object is a real estate cost object representing a piece of property, the real estate cost object may contain an address of the property, size of the property, number of rooms, appliances at the property, rent, property taxes, or any other attribute related to the real estate cost object. It is noted that configured cost objects may be generated for any type of specialized industry or business such as managing, renting, and maintaining equipment (e.g., the cost object may then be configured to represent equipment).

A user interface for creating the configured cost object that represents the specialized business item is provided. Data that mirrors the configured cost object is received, which results in a mirror cost object. Accounting operations are performed in the accounting system based on the mirror cost object and a corresponding business configuration set by replacing the generic cost object with the mirror cost object. The corresponding business configuration set indicates functions applicable in accounting operations for the mirror cost object. Output based on performance of the accounting operations based on the mirror cost object and corresponding business configuration set are provided.

By using embodiments of the present invention, specialized or specific accounting systems do not need to be employed. Accordingly, one or more of the methodologies discussed herein may obviate a need for processing accounting information on a plurality of different accounting systems, which may have the technical effect of reducing computing resources used by one or more devices within the system. Examples of such computing resources include, without limitation, processor cycles, network traffic, memory usage, storage space, and power consumption.

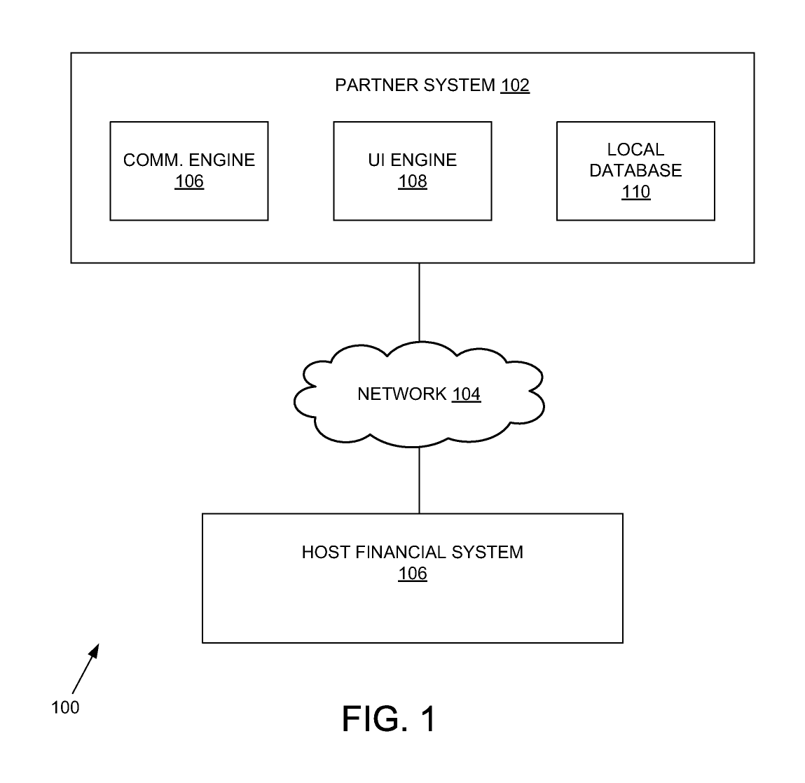

With reference to FIG. 1, an environment 100 in which example embodiments of the inventive subject matter may be practiced is shown. The environment 100 comprises a partner system 102 communicatively coupled via a network 104 to a host financial system 106. The partner system 102 is located at a partner location and manages data specific to the business needs of a partner or customer. For example, if the partner includes, as part of its business, real estate holdings, then specialized data managed by the partner system 102 may include real estate data such as addresses, rents, maintenance costs, property taxes, and so forth. In one example, the partner system 102 comprises a partner enterprise resource planning (ERP) system. However, the partner system 102 may comprise any logistical system which may contain a specialized business solution (e.g., real estate solution) to administer the specialized business (e.g., real estate).

In example embodiments, the partner system 102 is linked via the network 104 with the host financial system 106 to allow the host financial system 106 to perform accounting operations for the partner system 102. The network 104 may comprise the Internet, a wireless network, a cellular network, a Wide Area Network (WAN), or any other type of network which allows for exchange of communications.

In example embodiments, the partner system 102 may comprise a communication engine 106, a user interface (UI) engine 108, and a local database 110. The communication engine 106 is configured to manage communications including the exchange of data with the host financial system 106 via the network 104. As such, the communication engine 106 may receive instructions from the host financial system 106 for generating various user interfaces and provide data related to a configured cost object and business configuration set to the host financial system 106.

The UI engine 108 is configured to generate and display user interfaces to users of the partner system 102 based on instructions received from the host financial system 106. The user interfaces may include, for example, interfaces for configuring cost objects, posting notifications to the host financial system 106, and displaying generated reports received from the host financial system 106. For example, the user interface may allow the user to enter attributes to configure a cost object. In example embodiments, instructions for generating the user interfaces may be provided by the host financial system 106 and received by the communication engine 106 via the network 104. The UI engine 108 may then use the instructions from the host financial system 106 to render and display the user interfaces.

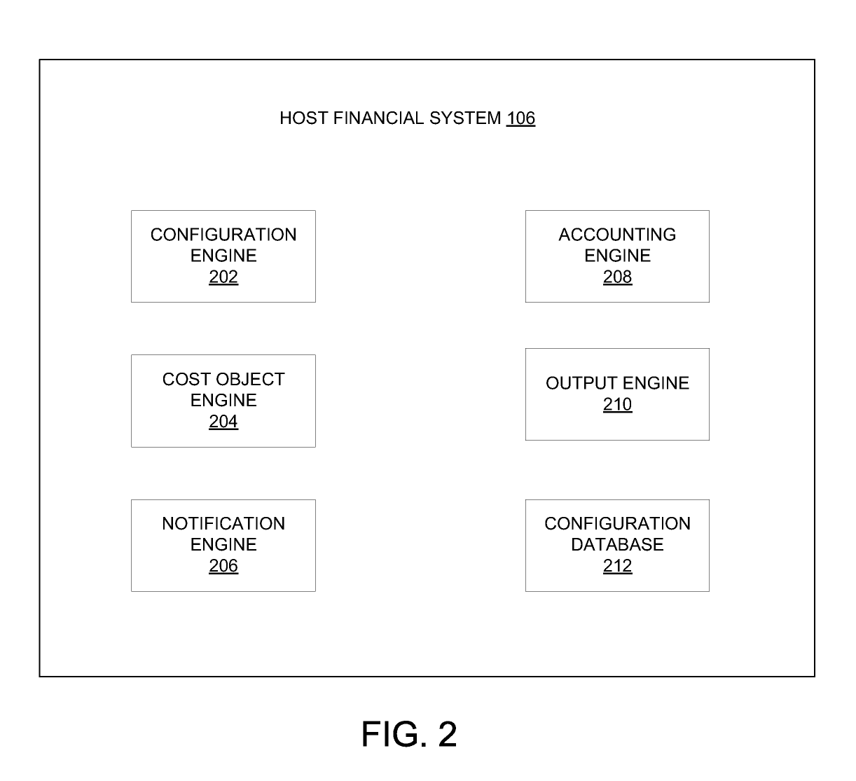

In one embodiment, the host financial system 106 may be part of an on-demand system which is hosted by a service provider. The on-demand system comprises one or more network applications that provide services and support to a customer (e.g., partner) without the customer having to host the system on their premise. That is, the service provider hosts (e.g., offers, provides, implements, executes, or performs one or more operations of) the systems and the customer can assess functionalities online through a software-as-a-service (SaaS) model. The on-demand systems may include, for example, services and support for supply chain management, human resource management, customer relationship management (CRM), financial and accounting management, compliance management, supplier relationship management, or any other form of business management. The host financial system 106 will be discussed in more detail in connection with FIG. 2 below.

The environment 100 of FIG. 1 is merely one example and alternative embodiments may comprise any number of partner systems 102 communicatively coupled to any number of host financial systems 106. Furthermore, components and functions of the partner system 102 and the host financial system 106 may be combined, separated, or be located elsewhere in the environment 100. Additionally, while examples are discussed with respect to an ERP system of a partner, it is noted that any type of partner system that can configure cost objects and provide notifications to the host financial system 106 may be used.

FIG. 2 is a block diagram illustrating the host financial system 106 in further detail. In accordance with example embodiments, the host financial system 106 comprises an accounting system that enables, for example, creation of balance sheets and ledgers. The accounting system is capable of processing standard objects like cost centers, purchase orders, and other standard business processes of an entity (e.g., company, partner). However, in order to handle specialized businesses or industries such as real estate or equipment management, configured cost objects are used. As such, if the partner wants to develop a specialized solution that is customized to their business or industry, the partner develops customized cost objects to be used with the accounting system of the host financial system 106. In turn, the host financial system 106 maintains an accounting system that includes generic cost objects which may be replaced with configured cost objects (e.g., customized cost objects of a partner) during accounting operations. To enable the use of the accounting system of the host financial system 106, the host financial system 106 comprises a configuration engine 202, a cost object engine 204, a notification engine 206, an accounting engine 208, an output engine 210, and a configuration database 212, which may all be communicatively coupled together.

The configuration engine 202 is configured to manage a business configuration set for the partner. In example embodiments, the partner system 102 provides the business configuration set that corresponds to their configured cost objects. The business configuration set comprise parameters that define different types of cost objects and corresponding functions on the accounting system at the host financial system 106 including, for example, ledger types, settlement, and overhead costs that may be used in performing accounting operations for the partner. As such, the partner may decide the kinds of functions to be used with particular types of cost objects using the business configuration set. The business configuration set may be stored in the configuration database 212. While the configuration database 212 is shown within the host financial system 106, alternative embodiments may locate the configuration database 212 outside of, but coupled to, the host financial system 106. In some embodiments, the configuration engine 202 provides instructions to the partner system 102 to generate and display a user interface for generating and updating the business configuration set.

The cost object engine 204 is configured to manage configured cost object data received from the partner system 102. In example embodiments, the host financial system 106 includes a free cost object (e.g., generic cost object) in its accounting operations. The free cost object is customized to reflect the specialized needs of the partner. Accordingly, the configured cost object of the partner may be linked to the free cost object in the accounting system of the host financial system 106 in order to integrate the configured cost object of the partner into standard account processes of the host financial system 106 by replacing the free cost object in accounting operations.

In some embodiments, the cost object engine 204 provides instructions to the partner system 102 to render and display a user interface for configuring the cost object into a configured cost object that represents a specialized business item of the partner (e.g., real estate or piece of equipment). The user interface allows the partner to enter attributes to generate the configured cost object at the partner system 102. Once the cost object is configured by the partner, a mirror of the configured cost object (referred to as a mirror cost object) may be received by the cost object engine 204. In some embodiments, the mirror cost object may be generated by the cost object engine 204 based on data associated with the configured cost object or otherwise linked to the configured cost object. For example, if the partner generates an apartment cost object (e.g., a configured cost object representing an apartment) via the user interface provided by the UI engine 108 as instructed by the cost object engine 204, the UI engine 108 or the cost object engine 204 creates a mirror instance of the configured cost object for the host financial system 106. The mirror instance of the configured cost object (or mirror cost object) will have a type identified as “apartment.” The apartment (mirror) cost object may also have an identifier (e.g., apartment #11). This identifier provides a cost object identifier (ID). Therefore, the configured cost object and mirror cost object have at least two parameters: cost object type (e.g., apartment) and cost object ID (e.g., 11).

The notification engine 206 is configured to manage notifications (e.g., data posts) received from the partner system 102. In example embodiments, the notification engine 206 receives postings specific to mirror cost objects. These postings may comprise financial notifications, such as costs, revenues, and invoices that are to be posted or attached to the mirror cost object. Additionally, the notifications may comprise other data that is to be attached to the mirror cost object, such as contracts, notes, free text, or other documents or information. In one embodiment, the notifications may become an entry in a journal or ledger.

In order to post a notification that is associated with a mirror cost object representing a business item, a user interface is provided to the partner. Accordingly, the partner may use the user interface to supply the information to be posted to the host financial system 106. In a further embodiment, the partner may access the mirror cost object stored at the host financial system 106 and provide notifications to be attached to the mirror cost object. In yet another embodiment, a further cost object may be configured in a similar manner to represent the financial notification (e.g., lease, insurance policy). For example, the partner may have a lease contract that they want to attach to a real estate cost object. A cost object may be configured to reflect attributes of the lease contract. For instance, the cost object may be configured to have a type (e.g., lease), an identifier (e.g., identifier of the lease), and any other attribute or data that distinguishes the lease from other contracts or leases. The configured cost object may then be posted to the host financial system 106 via the notification engine 206. As such, the type of business object (e.g., financial documents) the partner uses is irrelevant. Any type of business object may be combined with generic cost objects and be used as a specialized type of cost or revenue object.

The accounting engine 208 is configured to manage accounting operations of the host financial system 106. In example embodiments, the accounting engine 208 maintains an accounting system having generic cost objects. Using the mirror cost objects (e.g., for the items as well as the cost/revenue financial notifications) in place of the generic cost objects, the accounting engine 208 performs various accounting operations to obtain an output that may be provided to the partner. In some embodiments, the accounting engine 208 is part of, or comprises, the accounting system of the host financial system 106.

The output engine 210 is configured to manage results of the accounting operations. In example embodiments, the output engine 210 may provide ledgers or reports to the partner. For example, the output engine 210 may provide access to the ledgers, reports, or other financial information via the network 104.

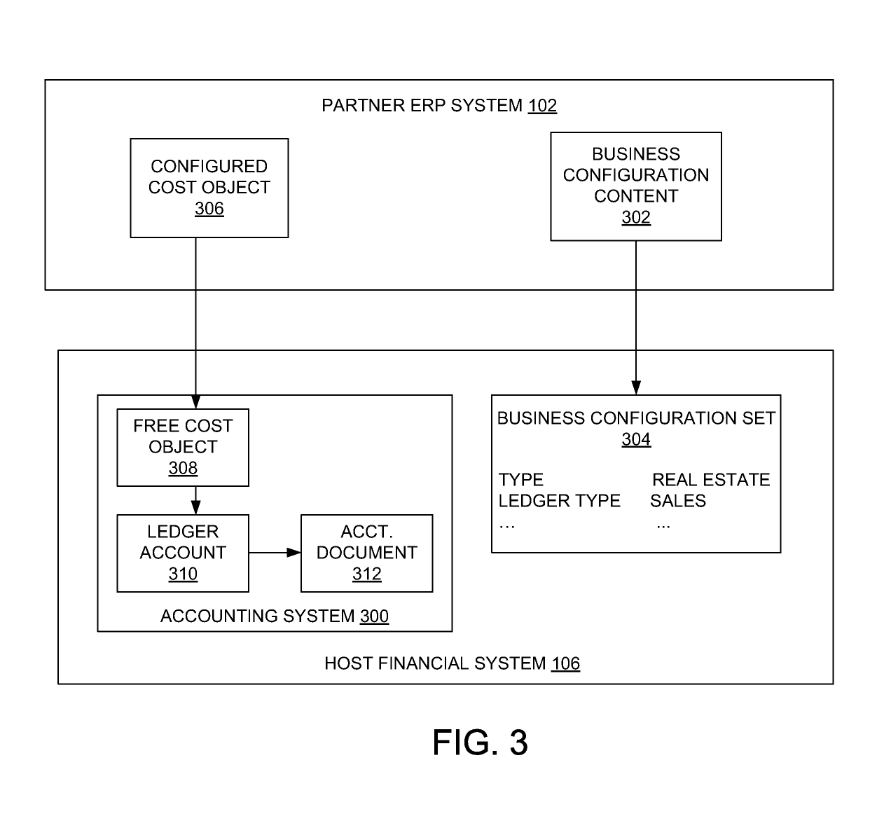

FIG. 3 is an information flow diagram for configuring a generic cost object in an accounting system 300. The accounting system 300 comprises standard accounting software for creating, for example, balance sheets using known standard objects such as cost centers, purchase orders, and other standard business processes of a company. In order for the accounting system 300 to handle specialized businesses or industries, specialized objects (e.g., configured and mirror cost objects) are required.

In example embodiments, the configuration engine 202 provides instructions to the partner system 102 to generate and display a user interface (UI) for configuring the business configuration set. Using this control setting UI, a user at the partner system 102 may enter business configuration content 302. The business configuration content 302 is received by the configuration engine 202 and stored in the configuration database 212. The business configuration content 302 provides a business control set 304 that is accessed when accounting operations with respect to mirror (specialized) cost objects are performed. For example as shown in FIG. 3, the business configuration set 304 may identify that for a mirror cost object having a real estate type, a ledger type used is a sales ledger. The business configuration set 304 may also indicate the types and functions of accounting operations to be performed with respect to the identified type (e.g., real estate) of the mirror cost object.

Furthermore, the cost object engine 204 provides instructions to the partner system 102 to generate and display a user interface for configuring the cost objects. Using this user interface, a user at the partner system 102 may provide attributes that configure a generic cost object provided by the cost object engine 204 into a configured cost object 306. The data representing the configured cost object 306 is used to generate a mirror cost object at the host financial system 106. The mirror cost object is used to replace a generic (free) cost object 308 in the accounting system 300 during accounting operations. The accounting system 300 may update a ledger account 310 using data associated with the mirror cost object and generate an account document 312. In example embodiments, the accounting document 312 may comprise journals, ledgers, or any other types of accounting recordkeeping documents.

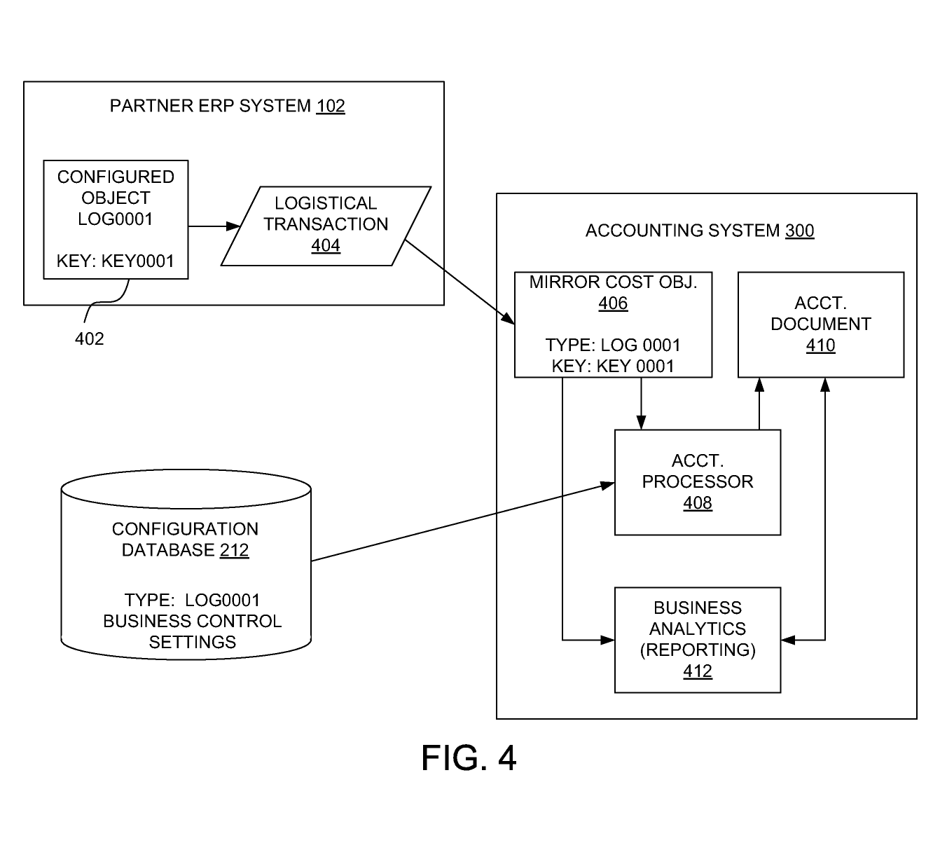

FIG. 4 is an example information flow diagram for performing accounting operations using a mirror cost object in the accounting system 300 of the host financial system 106. The accounting system 300 may comprise the accounting engine 208. In example embodiments, a user at the partner system 102 configures a cost object resulting in a configured cost object (e.g., master data-like object). In the present example, the configured cost object 402 is assigned attributes of a type “LOG0001” with an identifier (e.g., key) of “KEY0001”. Using a logistical transaction 404, data representing the configured cost object 402 is transmitted or linked to the accounting system 300. This data is used to configure a generic cost object in the accounting system 300 into a mirror cost object 406 that mirrors the configured cost object 402 (e.g., the master-data like object at the partner system 102). As such, the mirror cost object 406 represents the configured cost object 402 at the accounting system 300. Accordingly, when the configured cost object 402 is created, the mirror cost object 406 is also created with some reference fields that represent and enable the link between the two objects being filled.

During accounting operations, an accounting processor 408 receives the mirror cost object 406 information and accesses the configuration database 212 to determine a business configuration set that corresponds to the mirror cost object 406. In example embodiments, the business configuration set may indicate types of accounting functions/operations to be performed as well as types of output for the mirror cost object 406. Using the mirror cost object 406, attached notifications, and the business configuration set for the mirror cost object 406, the accounting processor 408 performs the accounting operations which result in an update to, or generation of, at least one accounting document 410. In example embodiments, the accounting document 410 may comprise journals, ledgers, or any other types of accounting recordkeeping documents.

A business analytics 412 may report or provide access to the accounting documents. In one embodiment, the business analytics 412 may comprise the output engine 210.

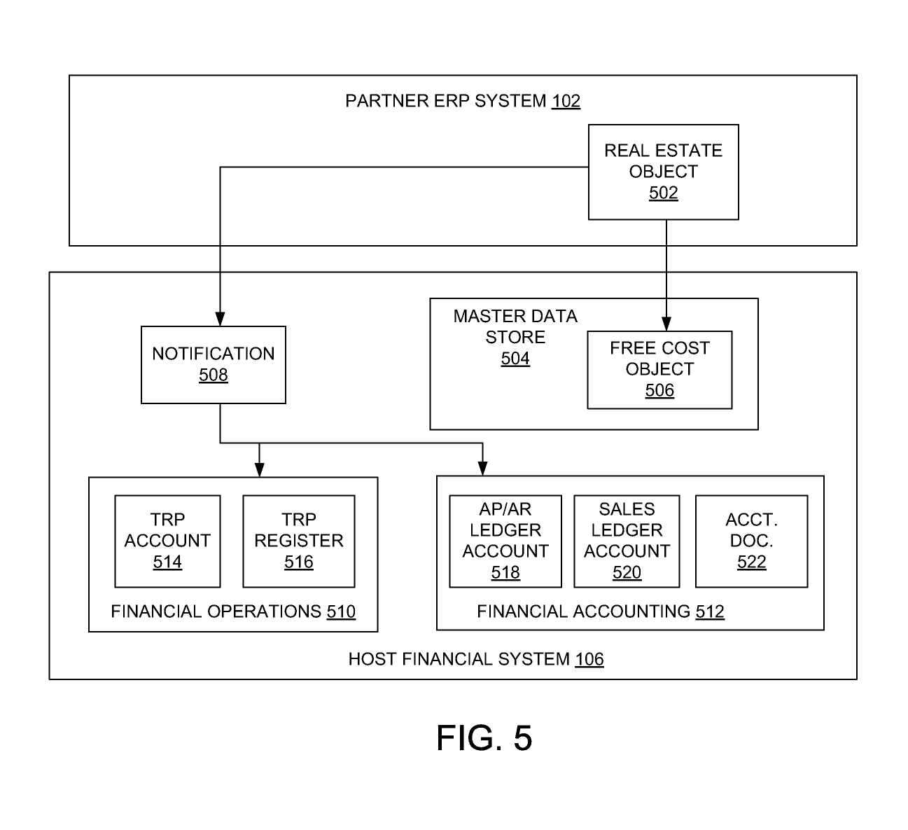

FIG. 5 is an example information flow diagram for posting financial notifications to the host financial system 106. As with the configured cost object that represents a specialized business item, the partner system 102 may configure a cost object to represent a financial notification (e.g., lease, insurance, invoice, revenues, costs, rents) in accordance with one embodiment. In the present example, the configured cost object is a real estate object 502. Data representing the real estate object 502 may be provided to a master data store 504 to configure a generic (free) cost object 506 to mirror the real estate object 502. The cost object in the master data store 504 (e.g., mirror cost object) may be configured to reflect attributes of a real estate property.

The same user interface or a second user interface allows the partner to provide data or documents to be posted to the mirror cost object. The data or documents may be provided as a notification 508. The notification 508 may be supplied to financial operations 510 and financial accounting 512 of the host financial system 106. The financial operations 510 may include a TRP account 514 and a TRP register 516. The TRP account 514 is a business object which represents the (business) partner to whom invoices are sent and received from. The TRP register 516 is a business object in which open and cleared items are stored. An open item may be, for example an unpaid invoice while a cleared items may be a paid invoice.

In example embodiments, the financial accounting 512 may be the accounting engine 208 or the accounting system 300. The financial accounting 512 includes an AP/AR (accounts payable/accounts receivable) ledger account 518, sales ledger account 520, and accounting documents 522. Each accounting document 522 may represent a journal entry and contains several items. A sum of values of these items may equal zero (e.g., balance is zero). Each item updates a general ledger but belongs to a specific subledger. For example, the accounting document 522 for a customer invoice may have three items: a receivables item, a revenue item, and a tax item. The receivables item belongs to (or is stored in) the AP/AR ledger account 518, which is a business object. Root nodes of its instances are referred to as ARP ledger accounts. It has a subnode that represents the items that belong to this business partner. The revenue item is stored in the sales ledger account 520 (e.g., root node represents the sales order or a single invoice) and the tax item is stored in a tax ledger account (not shown).

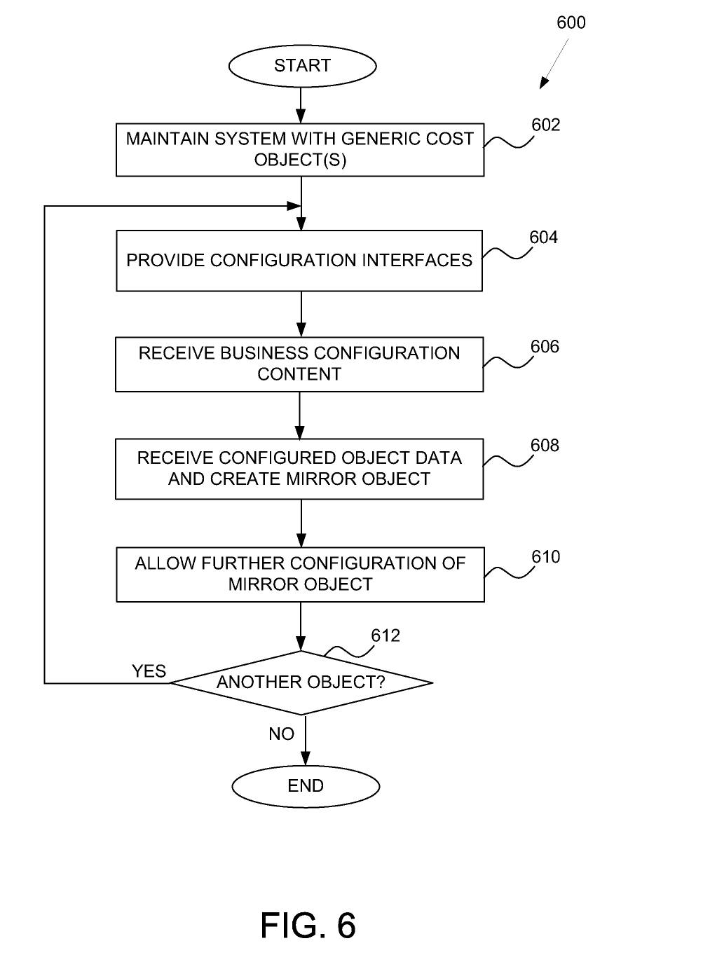

FIG. 6 is a flowchart of a method 600 for integrating the partner system 102 into the host financial system 106 using generic cost objects. In operation 602, the host financial system 106 maintains an accounting system having generic cost objects. According to example embodiments, the generic cost objects may be configured by a user at the partner system 102 to reflect a specialized business item or financial data corresponding to the specialized business item for accounting operations. As a result, the partner does not need to use or subscribe to multiple different accounting systems in order to handle accounting operations specific to their business items or needs.

In operation 604, instructions for configuration interfaces are provided by the host financial system 106. In example embodiments, the configuration engine 202 may provide instructions for generating a user interface that allows the partner to configure business configuration sets associated with configured cost objects of the partner. For example, the user interface may provide a set of standard functions for cost objects from which the partner may select functions applicable to cost objects which the partner will utilize. This business configuration set is received in operation 606.

Furthermore in operation 604, the configuration engine 202 may provide a user interface to the partner system 102 to allow the partner to configure a generic cost object into a configured cost object that represents a specialized business item of the partner. The user interface may include fields or menus that allow the partner to provide attributes that describe the business item. For example, if the business item is an office building, the attributes may include a type (e.g., office building) and an identifier (e.g., address of the office building). Other attributes may include associated profit centers, company identifiers, names, and descriptions. The configured object data is received and a mirror object is created in operation 608. Therefore, by configuring the cost object and the business configuration set, the partner can automatically create an instance of the generic cost object by creating the partner's own object (e.g., real estate object) in the partner system 102 that is mirrored (with a mirror cost object) at the host financial system 106.

In operation 610, further configuration of the mirror cost object may be performed by the partner. In example embodiments, the partner may access the mirror cost object stored at the host financial system 106 and make changes or provide attachments or notes. The partner may, for example, upload an attachment in a partner user interface, which is then attached to the mirror cost object.

In operation 612, a determination is made as to whether a further cost object and further business configuration set need to be configured. If a further cost object and further business configuration set are needed, then the method 600 returns to operation 604.

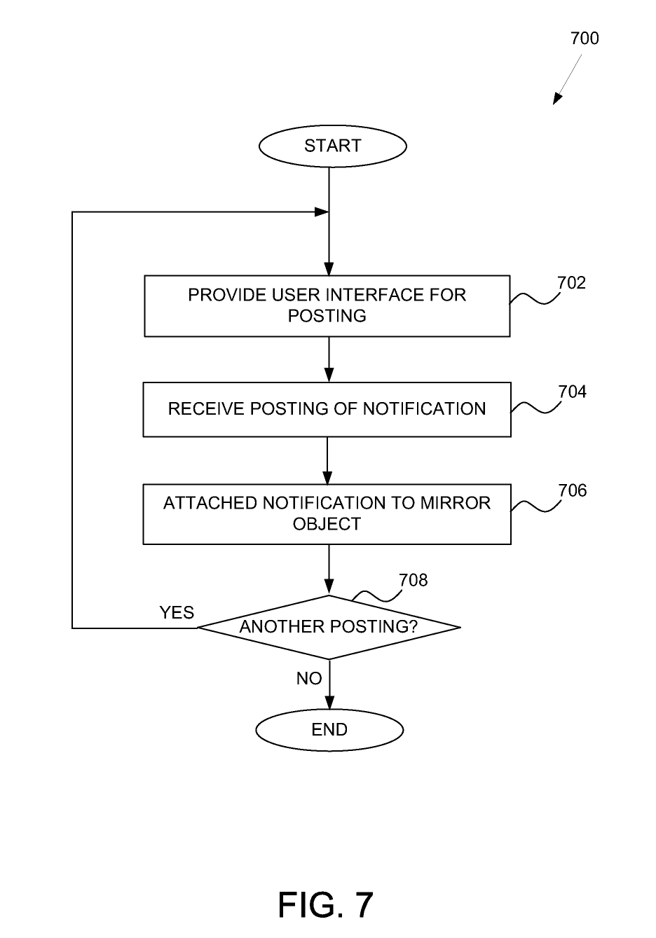

FIG. 7 is a flowchart of a method 700 for posting notifications to the host financial system 106. In operation 702, a user interface for posting of notifications is provided. Notifications may comprise any information that is related to a mirror cost object which the partner wants associated with the mirror cost object. For example, the mirror cost object may comprise notes, free text, attachments, financial data (e.g., invoices, credits, debits), contracts, or any other information or documents relevant to a mirror cost object. The user interface may be accessed by the partner at the host financial system 106 or may be provided to the partner system 102 by the notification engine 206. In some embodiments, the method 700 may comprise operation 610.

In operation 704, the host financial system 106 receives a posting of a notification. The notification will indicate the mirror cost object with which to associate the notification. As such, the user interface allows the user to indicate the mirror cost object to which the notification should be attached or posted. The notification is then attached to the indicated mirror cost object in operation 706.

A determination is made at operation 708 as to whether another posting is available. If another posting is available, then the method 700 returns to operation 702. However, if no further postings are available or needed, then the method ends. The accounting system may, at any time, apply accounting operations to some or all of the notifications (e.g., financial data) attached to the mirror cost object.

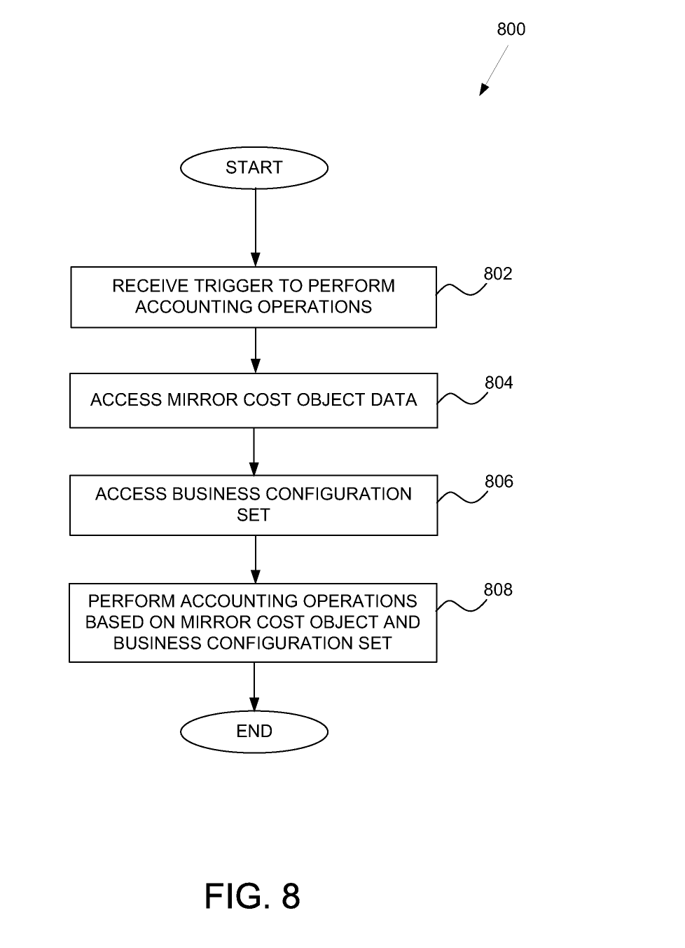

FIG. 8 is a flowchart of an example method 800 for performing accounting operations at the host financial system 106. In operation 802, the accounting engine 208 receives an accounting operation trigger. The trigger may be manually triggered by a partner, be automatically scheduled to occur at predetermined times, or by any other means of triggering the accounting operations.

The accounting engine 208 accesses mirror cost object data in operation 804. The mirror cost object and associated data and attributes may be stored to a storage device of the host financial system 106. The accounting engine 208 retrieves the data associated with the mirror cost object such as, for example, object type and object identifier.

The business configuration set is accessed in operation 806. In example embodiments the accounting engine 208 accesses the business configuration set stored in the configuration database 212. Alternatively, the configuration engine 202 may access the business configuration set. The business configuration set comprises parameters that indicate what functions or operations are to be performed with each object type. Thus, using the mirror cost object data retrieved in operation 804, the appropriate accounting operations may be determined from the business configuration set in operation 806. Accordingly, the accounting operations may be performed in operation 808.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term “module” or “engine” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules, engines, or components are temporarily configured (e.g., programmed), each of the modules, engines, or components need not be configured or instantiated at any one instance in time. For example, where the modules, engines, or components comprise a general-purpose processor configured using software, the general-purpose processor may be configured as respective different modules at different times. Software may accordingly configure the processor to constitute a particular module or engine at one instance of time and to constitute a different module or engine at a different instance of time.

Modules or engines can provide information to, and receive information from, other modules or engines. Accordingly, the described modules and engines may be regarded as being communicatively coupled. Where multiples of such modules and engines exist contemporaneously, communications may be achieved through signal transmission (e.g., over appropriate circuits and buses) that connect the modules and engines. In embodiments in which multiple modules and engines are configured or instantiated at different times, communications between such modules and engines may be achieved, for example, through the storage and retrieval of information in memory structures to which the multiple modules or engines have access. For example, one module may perform an operation and store the output of that operation in a memory device to which it is communicatively coupled. A further module may then, at a later time, access the memory device to retrieve and process the stored output. Modules and engines may also initiate communications with input or output devices and can operate on a resource (e.g., a collection of information).

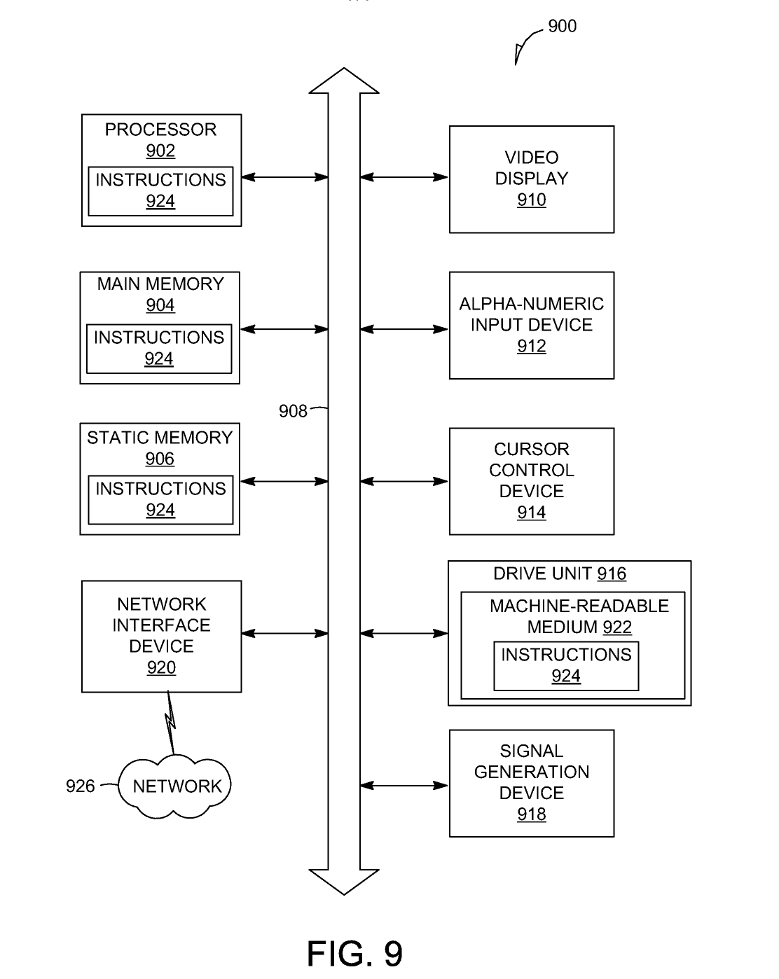

With reference to FIG. 9, an example embodiment extends to a machine in the example form of a computer system 900 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, a server, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 may include a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). In example embodiments, the computer system 900 also includes one or more of an alpha-numeric input device 912 (e.g., a keyboard), a user interface (UI) navigation device or cursor control device 914 (e.g., a mouse), a disk drive unit 916, a signal generation device 918 (e.g., a speaker), and a network interface device 920.

The disk drive unit 916 includes a machine-readable storage medium 922 on which is stored one or more sets of instructions 924 and data structures (e.g., software instructions) embodying or used by any one or more of the methodologies or functions described herein. The instructions 924 may also reside, completely or at least partially, within the main memory 904 or within the processor 902 during execution thereof by the computer system 900, the main memory 904 and the processor 902 also constituting machine-readable media.

While the machine-readable storage medium 922 is shown in an exemplary embodiment to be a single medium, the term “machine-readable storage medium” may include a single storage medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that causes the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories, optical and magnetic media, and non-transitory machine-readable storage media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 924 may further be transmitted or received over a communications network 926 using a transmission medium via the network interface device 920 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As used herein, the term “or” may be construed in either an inclusive or exclusive sense. Additionally, although various example embodiments discussed focus on a specific network-based environment, the embodiments are given merely for clarity in disclosure. Thus, any type of electronic system, including various system architectures, may employ various embodiments of the search system described herein and is considered as being within a scope of example embodiments.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

1. A method comprising:
maintaining, at a host financial system, an accounting system with a generic cost object;
causing, at a system of an entity distinct from the host financial system, presentation of a user interface that allows the entity to create a configured cost object that represents a specialized business item;
receiving data associated with the configured cost object from the system of the entity distinct from the host financial system;
creating a mirror cost object using the received data associated with the configured cost object at the host financial system, the mirror cost object mirroring the configured cost object;
performing, using a processor of a machine, accounting operations in the accounting system based on the mirror cost object and a corresponding business configuration set by replacing the generic cost object at the host financial system with the mirror cost object; and
providing output based on performance of the accounting operations based on the mirror cost object and the corresponding business configuration set to the entity.

2. The method of claim 1, further comprising receiving the corresponding business configuration set, the corresponding business configuration set indicating functions applicable in accounting operations for the mirror cost object.

3. The method of claim 1, wherein the specialized business item comprises a tangible good of the entity.

4. The method of claim 1, further comprising causing presentation of a second user interface for posting of notifications to the mirror cost object at system of the entity.

5. The method of claim 1, further comprising receiving a notification, the notification representing data to be attached to the mirror cost object.

6. The method of claim 5, wherein the notification comprises data indicating cost or revenue associated with the mirror cost object.

7. The method of claim 5, wherein the notification provides an entry to a ledger associated with the mirror cost object.

8. The method of claim 1, wherein the performing of the accounting operations comprises:
accessing a configuration database storing the corresponding business configuration set; and
providing the corresponding business configuration set to an accounting processor.

9. The method of claim 1, wherein the performing of the accounting operations comprises at least one selection from the group consisting of performing AP/AR ledger accounting calculations, performing sales ledger accounting calculations, and generating an account document.

10. The method of claim 1, further comprising allowing customization of the mirror cost object at the host financial system.

11. A system comprising:
a processor of a machine;
an accounting engine configured to maintain, at a host financial system, an accounting system with a generic cost object;
a cost object engine configured to cause, at a system of an entity distinct from the host financial system, presentation of a user interface that allows the entity to create a configured cost object that represents a specialized business item, to receive data associated with the configured cost object from the system of the entity distinct from the host financial system, and to create a mirror cost object using the received data associated with the configured cost object at the host financial system, the mirror cost object mirroring the configured cost object; and
an output engine configured to provide output based on performance of accounting operations based on the mirror cost object and a corresponding business configuration set to the entity,
the accounting engine further configured to perform, using the processor, the accounting operations in the accounting system based on the mirror cost object and the corresponding business configuration set by replacing the generic cost object at the host financial system with the mirror cost object.

12. The system of claim 11, further comprising a configuration engine configured to receive the corresponding business configuration set, the corresponding business configuration set indicating functions applicable in accounting operations for the mirror cost object.

13. The system of claim 11, further comprising a notification engine configured to cause presentation of a second user interface for posting of notifications to the mirror cost object at the system of the entity and to receive the notification, the notification representing data to be attached to the mirror cost object.

14. The system of claim 11, wherein the accounting engine is configured to perform the accounting operations by:
accessing a configuration database storing the corresponding business configuration set; and
providing the corresponding business configuration set to an accounting processor.

15. A non-transitory machine-readable medium in communication with at least one processor, the non-transitory machine-readable storage medium storing instructions, which when executed by the at least one processor of a machine, cause the machine to perform operations comprising:
maintaining, at a host financial system, an accounting system with a generic cost object;
causing, at a system of an entity distinct from the host financial system, presentation of a user interface that allows the entity to create a configured cost object that represents a specialized business item;
receiving data associated with the configured cost object from the system of the entity distinct from the host financial system;
creating in a mirror cost object using the received data associated with the configured cost object at the host financial system, the mirror cost object mirroring the configured cost object;
performing, using a processor of a machine, accounting operations in the accounting system based on the mirror cost object and a corresponding business configuration set by replacing the generic cost object at the host financial system with the mirror cost object; and
providing output based on performance of the accounting operations based on the mirror cost object and the corresponding business configuration set to the entity.

16. The non-transitory machine-readable medium of claim 15, wherein the operations further comprise receiving the corresponding business configuration set, the corresponding business configuration set indicating functions applicable in accounting operations for the mirror cost object.

17. The non-transitory machine-readable medium of claim 15, wherein the operations further comprise:
causing presentation of a second user interface for posting of notifications to the mirror cost object at the system of the entity; and
receiving a notification, the notification representing data to be attached to the mirror cost object.

18. The non-transitory machine-readable medium of claim 15, wherein the performing of the accounting operations comprises:
accessing a configuration database storing the corresponding business configuration set; and
providing the corresponding business configuration set to an accounting processor.

19. The non-transitory machine-readable medium of claim 15, wherein the performing of the accounting operations comprises at least one selection from the group consisting of performing AP/AR ledger accounting calculations, performing sales ledger accounting calculations, and generating an account document.

20. The non-transitory machine-readable medium of claim 15, wherein the operations further comprise allowing customization of the mirror cost object at the host financial system.
